(19) United States
(12) Patent Application Publication
(10) Pub. No.: US 2022/0176447 A1
(43) Pub. Date: Jun. 9, 2022

(54) METHOD OF PRODUCING SOLID SPHERICAL POWDER,AND METHOD OF PRODUCING SHAPED PRODUCT

(71) Applicant: FURUYA METAL CO., LTD., Toshima-ku, Tokyo (JP)

(72) Inventors: Genki ANO, Toshima-ku, Tokyo (JP); Tomohiro MARUKO, Toshima-ku, Tokyo (JP); Tomoaki MIYAZAWA, Toshima-ku, Tokyo (JP); Yuichi IWAMOTO, Toshima-ku, Tokyo (JP); Satoshi KITA, Toshima-ku, Tokyo (JP)

(21) Appl. No.: 17/442,512

(22) PCT Filed: Mar. 25, 2020
(86) PCT No.: PCT/JP2020/013198

§ 371 Date: Sep. 23, 2021

(30) Foreign Application Priority Data
Mar. 27, 2019 (JP) 2019-061338

(51) Int. Cl. B22F 1/142; B22F 1/0655; B22F 1/05; B22F 1/148; B22F 10/28; B33Y 40/10; B33Y 70/00

(52) U.S. Cl. CPC B22F 1/142; B22F 1/0655; B22F 1/05; B22F 1/148; B33Y 10/00; B33Y 40/10; B33Y 70/00; B22F 2304/10; B22F 10/28

(57) ABSTRACT

The method of producing a solid spherical powder according to the present disclosure includes: a step A of preparing a first powder raw material containing agglomerated particles and/or solidified particles having a particle diameter of 1 μm to 1,000 μm and introducing the first powder raw material into a plasma flame to produce a hollow spherical powder having a surface layer shell having a thickness of 1 μm to 50 μm; a step B of subjecting the hollow spherical powder to pulverization treatment to pulverize a hollow shape of the hollow spherical powder, thus obtaining a second powder raw material which is solid; and a step C of introducing the second powder raw material into a plasma flame, melting and solidifying the second powder raw material to obtain the solid spherical powder.

### TECHNICAL FIELD

The present disclosure relates to a method of producing a solid spherical powder and a method of producing a shaped product, and for example, relates to a method of producing a highly flowable solid spherical powder made of a high-melting point and difficult-to-process metal with a high yield, and a method of producing a shaped product having a high relative density using the solid spherical powder as a material for additive manufacturing.

### BACKGROUND ART

When difficult-to-process metal materials having excellent high-temperature characteristics typified by iridium, ruthenium, or the like are used for industrial products, there is a problem that it is difficult to perform machine processing and press processing, the processing requires long time, and causes very large labor and material loss, so that the production of a product having a complicated shape is extremely difficult.

In recent years, an additive manufacturing method for a metal has attracted attention as a new production technique. In particular, electron beam melting (EBM), selective laser melting (SLM), and laser metal deposition (LMD) are well known, and any method enables near net shape forming that is producing a complex-shaped product in a shape close to a finished product. By using this technique for the difficult-to-process metal materials having excellent high-temperature characteristics such as iridium and ruthenium, it is possible to produce a complex-shaped product having excellent high-temperature characteristics, which has been difficult to produce in the conventional art, and to expand their applications to a wider range.

In the additive manufacturing method, the properties of a powder to be a material are very important factors that affect the product quality. When the powder is too fine or too coarse in supply of the powder to be a material, the powder exhibits inhibition of flowability due to aggregation or segregation, so that the additive manufacturing process becomes unstable and a shaped product having a low relative density is obtained (see, for example, Non-Patent Literature 1). Therefore, in order to obtain a shaped product having excellent quality, high flowability and narrow particle diameter distribution (synonymous with particle size distribution) are required for the powder to be a material. A spherical powder having a uniform particle diameter is generally used as the powder to be a material.

In a method of producing a spherical powder used in the additive manufacturing method, a gas atomization method of supplying a thin stream of molten metal is mainly used because of high productivity. This production method requires a tundish that stores the molten metal to be supplied and an orifice through which a thin stream of the molten metal flows out.

As a method of producing a spherical powder of a high-melting point metal without using a container such as a tundish or a jig such as an orifice, an electrode induction melting gas atomization method has been proposed (for example, see Patent Literature 1).

In general, since the gas atomization method and the electrode induction melting gas atomization method are spherical powder production methods in which gas is atomized into molten metal, the atomization gas naturally enters the molten metal, thus causing a problem that unintended intraparticle pores remain in the spherical powder. This problem is avoided as a factor of pores and defects of the shaped product, and a countermeasure for preventing the intraparticle pores from remaining in the spherical powder has become an issue (for the problem, see, for example, Non-Patent Literature 2).

As a method of producing a spherical powder of a high-melting point metal without using a container such as a tundish or a jig such as an orifice, a wire supply type plasma atomization method has been proposed (see, for example, Non-Patent Literature 3).

Furthermore, as a method of producing a spherical powder of a high-melting point metal without using a container such as a tundish or a jig such as an orifice, a powder supply type plasma processing technique has been proposed (for example, see Patent Literature 2). In this technique, since the spherical powder is finished according to the particle size of the supplied raw material powder, it is possible to produce the spherical powder with good yield as long as the size of the raw material powder can be adjusted.

### CITATION LIST

### Patent Literature

Patent Literature 1: JP 01-062404 A
Patent Literature 2: JP 04-246104 A

### Non-Patent Literature

Non-Patent Literature 1: A. Simchi, Metallurgical and Materials Transactions B, 35B, 2004, pp. 937-948.
Non-Patent Literature 2: Hideki Kyogoku and another 21 persons, “Introduction of Metal Additive Manufacturing Technology for Designers and Engineers”, edited by Technology Research Association for Future Additive Manufacturing, published by Technology Research Association for Future Additive Manufacturing and With Up Co., Ltd., September 2016, pp. 63-66.
Non-Patent Literature 3: A. Alagheband and C. Brown, Metal Powder Report 53 (11), 1988, pp. 26-28.

### SUMMARY OF INVENTION

### Technical Problem

However, in the gas atomization method, which is a procedure of supplying the thin stream of the molten metal, when a spherical powder of a high-melting point metal having a melting point of higher than 1,900° C. is produced, a material used for the tundish that stores the molten metal to be supplied, the orifice through which the thin stream of the molten metal flows out, or the like cannot withstand the extremely high temperature, and thus the gas atomization method, which is this procedure, cannot be applied.

In addition, in the method described in Patent Literature 1, since it is necessary to process a raw material to be used for dissolution into a prescribed round bar shape, there is a problem that a large amount of time and labor is required for preparing a raw material in case of a difficult-to-process material such as iridium or ruthenium. In addition, since the atomization gas enters the molten metal, there is a problem that unintended intraparticle pores remain in the powder produced by the method described in Patent Literature 1. In addition, the produced powder has a wide particle size distribution, causing a problem that a spherical powder having a particle diameter suitable for SLM or LMD in an amount of about only 10 to 20% of the total amount of the produced powder can be obtained.

In the method described in Non-Patent Literature 3, since it is necessary to process a raw material to be used for dissolution into a prescribed wire shape, in case of a difficult-to-process metal material such as iridium or ruthenium, a large amount of time and labor is spent in preparation of the raw material. In addition, the powder produced by the method described in Non-Patent Literature 3 has a wide particle size distribution, and a spherical powder having a particle diameter suitable for SLM and LMD in an amount of only about 10 to 20% of the total amount of the produced powder can be obtained.

In the method described in Patent Literature 2, when an iridium raw material powder having a uniform particle diameter, produced by a chemical reduction method was subjected to plasma treatment, the obtained iridium spherical powder had a high sphericity and excellent flowability, and the particle diameter was uniform to the same extent as that of the powder raw material, and thus the method was considered to be a powder production method suitable for additive manufacturing. However, a shaped product produced by the additive manufacturing using the spherical powder has a large number of pores therein and has a low relative density of 90%, and thus there is a problem that the shaped product according to the method described in Patent Literature 2 cannot be a product.

As a result of conducting the factor investigation of the pores, the present inventors have found that the spherical powder used for shaping has unintended intraparticle pores of about 1 μm to 10 μm, and have considered that such intraparticle pores remain in the shaped product at the time of shaping to form pores. In addition, the present inventors have considered that intraparticle pores are generated in the spherical powder by using a porous body as a raw material, and thus, have considered that a spherical powder without intraparticle pores can be produced by producing a solid powder raw material, and thus a shaped product having a high relative density can be produced.

Based on the above consideration, the present inventors have worked on the production of a powder raw material having a low porosity. Cut processing was selected as a method of producing the raw material powder, and a cutting powder was produced from an ingot using a lathe. However, since iridium has a high cutting load, the cutting speed is extremely slow, and in the cut processing of the present inventors, the amount of a cutting powder that can be produced within 1 hour was 50 g at the most. Since the obtained cutting powder has a wide particle size distribution, impact pulverization processing was employed, and the iridium cutting powder was made fine by a ball mill to adjust the particle size. However, since iridium has high strength, it was necessary to use a stainless steel jig having high impact energy for impact pulverization processing. As a result, the jig used for the impact pulverization processing was scraped, and the adulteration amount in the iridium powder increased. As described above, since iridium is a difficult-to-process material, and it has been very difficult to produce the powder having a low porosity with good yield.

Therefore, an object of the present disclosure is to provide a method of producing a highly flowable solid spherical powder that uses a high-melting point and difficult-to-process material as a raw material, has a high yield, and is easily formed into a desired particle size, and a method of producing a shaped product that uses the solid spherical powder as a material for additive manufacturing and has a high relative density.

### Solution to Problem

As a result of intensive studies to solve the above problems, the present inventors have focused on intraparticle pores remaining when a powder is spheroidized, have found that the above problems can be solved by controlling the intraparticle pores to obtain a hollow spherical powder having a thin surface layer shell which is easy to pulverize, subjecting the hollow spherical powder to pulverization treatment to produce a solid powder raw material, and spheroidizing the solid powder raw material, and thus have completed the present invention.

A method of producing a solid spherical powder according to the present invention includes: a step A of preparing a first powder raw material containing agglomerated particles and/or solidified particles having a particle diameter of 1 μm to 1,000 μm and introducing the first powder raw material into a plasma flame to produce a hollow spherical powder having a surface layer shell having a thickness of 1 μm to 50 μm; a step B of subjecting the hollow spherical powder to pulverization treatment to pulverize a hollow shape of the hollow spherical powder, thus obtaining a second powder raw material which is solid; and a step C of introducing the second powder raw material into a plasma flame, melting and solidifying the second powder raw material to obtain the solid spherical powder.

The method of producing the solid spherical powder according to the present invention preferably further includes a step D of classifying the second powder raw material and/or a step E of classifying the solid spherical powder. The solid spherical powder having a desired particle size can be more easily formed, and the flowability of the solid spherical powder can be further enhanced.

In the method of producing the solid spherical powder according to the present invention, an apparent density of the solid spherical powder defined in JIS Z 2504: 2012 “Metallic powders-Determination of apparent density” is preferably 50% or more with respect to a true density thereof. A raw material of a shaped product having a high relative density can be obtained.

In the method of producing the solid spherical powder according to the present invention, the pulverization treatment of the hollow spherical powder is preferably impact pulverization. The hollow spherical powder can be made fine to obtain a fine second powder raw material having an adjusted particle size.

In the method of producing the solid spherical powder according to the present invention, the first powder raw material is preferably composed of a metal or an alloy having a melting point of 1,900° C. or higher. Conventionally, in the production of a spherical powder, a heat-resistant jig having a melting point equal to or higher than that of a powder raw material is required, but in the present invention, since the spherical powder can be produced without touching the heat-resistant jig so much, a solid spherical powder can be produced even from a high-melting point metal or an alloy having a melting point of 1,900° C. or higher while suppressing wear of production equipment due to heat.

In the method of producing the solid spherical powder according to the present invention, the metal or the alloy having a melting point of 1,900° C. or higher is preferably any one of Ir, Ru, an Ir-based alloy and a Ru-based alloy. Conventionally, in the production of a spherical powder, a heat-resistant jig having a melting point equal to or higher than that of a powder raw material is required, but in the present invention, since the spherical powder can be produced without touching the heat-resistant jig so much, a solid spherical powder can be produced even from Ir, Ru, an Ir-based alloy, and a Ru-based alloy having a high melting point of 1,900° C. or higher, which have been difficult to process due to high hardness, while suppressing wear of production equipment due to heat.

In the method of producing the solid spherical powder according to the present invention, the first powder raw material preferably contains at least one of an electrolytic powder, a reduced powder, a mechanically alloyed powder, and a coated powder. It is possible to easily produce a hollow spherical powder which is easily pulverized.

A method of producing a shaped product according to the present invention is a method of producing a shaped product, wherein in an additive manufacturing method including a step of laminating layers obtained by at least partially melting and solidifying a powder to be irradiated by high-energy irradiation to form the shaped product, the powder to be irradiated is the solid spherical powder produced by the method of producing the solid spherical powder according to the present invention.

In the method of producing the shaped product of the present invention, a relative density of the shaped product is preferably 99% or more. It is possible to produce a shaped product having a complicated shape such as an electrode, a processing tool, and a crucible for p-PD method which are excellent in quality.

### Advantageous Effects of Invention

According to the present disclosure, it is possible to provide a method of producing a highly flowable solid spherical powder that uses a high-melting point and difficult-to-process material as a raw material, has a high yield, and is easily formed into a desired particle size, and a method of producing a shaped product that uses the solid spherical powder as a material for additive manufacturing and has a high relative density.

### BRIEF DESCRIPTION OF DRAWINGS

FIG. 1(a) is a scanning electron microscope (SEM) image of a first Ir powder raw material in Example 1, which is a low-magnification SEM image.

FIG. 1(b) is a scanning electron microscope (SEM) image of the first Ir powder raw material in Example 1, which is a high-magnification SEM image.

FIG. 2 is a graph showing a cumulative particle size distribution of the first Ir powder raw material and a cumulative particle size distribution of an Ir hollow spherical powder in Example 1.

FIG. 3 is an SEM image of the Ir hollow spherical powder in Example 1.

FIG. 4 is an optical microscope image of cross sections of the Ir hollow spherical powder in Example 1.

FIG. 5 is an optical microscope image of cross sections of a second Ir powder raw material after classification in Example 1.

FIG. 6 is a graph showing a cumulative particle size distribution of the second Ir powder raw material after classification and a cumulative particle size distribution of an Ir solid spherical powder in Example 1.

FIG. 7 is an SEM image of the Ir solid spherical powder after classification in Example 1.

FIG. 8 is an optical microscope image of cross sections of the Ir solid spherical powder after classification in Example 1.

FIG. 9(a) is an SEM image of a first Ru powder raw material in Example 2, which is a low-magnification SEM image.

FIG. 9(b) is an SEM image of the first Ru powder raw material in Example 2, which is a high-magnification SEM image.

FIG. 10 is a graph showing a cumulative particle size distribution of the first Ru powder raw material and a cumulative particle size distribution of a Ru hollow spherical powder in Example 2.

FIG. 11 is an SEM image of the Ru hollow spherical powder in Example 2.

FIG. 12 is an optical microscope image of cross sections of the Ru hollow spherical powder in Example 2.

FIG. 13 is an optical microscope image of cross sections of a second Ru powder raw material after classification in Example 2.

FIG. 14 is a graph showing a cumulative particle size distribution of the second Ru powder raw material after classification and a cumulative particle size distribution of a Ru solid spherical powder in Example 2.

FIG. 15 is an SEM image of the Ru solid spherical powder after classification in Example 2.

FIG. 16 is an optical microscope image of cross sections of the Ru solid spherical powder after classification in Example 2.

FIG. 17 is an SEM image of an Ir solid spherical powder in Comparative Example 1.

FIG. 18 is a graph showing a cumulative particle size distribution of the Ir solid spherical powder in Comparative Example 1.

FIG. 19(a) is an SEM image of a Pt-10Rh solid spherical powder undersize in Comparative Example 2, which is a low-magnification SEM image.

FIG. 19(b) is an SEM image of the Pt-10Rh solid spherical powder undersize in Comparative Example 2, which is a high-magnification SEM image.

FIG. 20 is an image of an appearance of a Pt-10Rh powder oversize in Comparative Example 2.

FIG. 21 is a graph showing a cumulative particle size distribution of the Pt-10Rh solid spherical powder undersize in Comparative Example 2.

### DESCRIPTION OF EMBODIMENTS

Hereinafter, the present invention will be described in detail with reference to embodiments, but the present invention is not construed as being limited to these descriptions. The embodiment may be variously modified as long as the effect of the present invention is exhibited.

A method of producing a solid spherical powder according to the present embodiment includes: a step A of preparing a first powder raw material containing agglomerated particles and/or solidified particles having a particle diameter of 1 μm to 1,000 μm and introducing the first powder raw material into a plasma flame to produce a hollow spherical powder having a surface layer shell having a thickness of 1 μm to 50 μm; a step B of subjecting the hollow spherical powder to pulverization treatment to pulverize the hollow shape of the hollow spherical powder, thus obtaining a second powder raw material which is solid; and a step C of introducing the second powder raw material into a plasma flame, melting and solidifying the second powder raw material to obtain the solid spherical powder.

<Step A>

The agglomerated particle is a particle formed by agglomeration of fine particles, and the solidified particle is a particle formed by solidification of fine particles. Here, the term “agglomeration” refers to being massed by mutual attractive force. The term “solidification” refers to a state of being firmly bonded. The term “fine particle” refers to a primary particle itself or a particle formed by agglomeration or solidification of primary particles. When the fine particle is a primary particle itself, the particle diameter of the fine particle is, for example, 1 nm to 100 nm from the viewpoint of the particle diameter of the primary particle in case of industrially producing the powder. When the fine particle is a particle formed by agglomeration or solidification of primary particles, since the agglomerated particle and the solidified particle are preferably porous bodies having high porosity, the particle diameter of the primary particle is preferably 1 nm to 100 nm, and the particle diameter of the fine particle is preferably 20 nm to 1,000 nm. Examples of the form of the first powder raw material containing agglomerated particles and/or solidified particles include a form of a first powder raw material containing agglomerated particles and not containing solidified particles, a form of a first powder raw material containing solidified particles and not containing agglomerated particles, and a form of a first powder raw material containing both agglomerated particles and solidified particles.

The particle diameter of the agglomerated particles and/or the solidified particles contained in the first powder raw material is 1 μm to 1,000 μm. The particle diameter is preferably 10 μm to 500 μm, and more preferably 50 μm to 300 μm. When the particle diameter is less than 1 μm, the particle diameter of the hollow spherical powder obtained in the step A is too small, and thus it is difficult to pulverize the hollow spherical powder. When the particle diameter exceeds 1,000 μm, a larger plasma flame is required when the hollow spherical powder is produced in the step A, and thus the production efficiency is deteriorated. The particle diameter of the agglomerated particles and/or the solidified particles can be measured by, for example, a particle size distribution measuring apparatus.

In the agglomerated particles, fine particles are agglomerated with gaps, and in the solidified particles, fine particles are solidified with gaps. Therefore, pores between fine particles are present inside the agglomerated particles and/or inside the solidified particles. Further, when the fine particles are secondary particles formed by agglomeration and/or solidification of the primary particles, the primary particles are agglomerated and/or solidified with gaps, so that pores inside the fine particles are present inside the fine particles which are the secondary particles. The pores between the fine particles and the pores inside the fine particles form pores inside the agglomerated particles and/or inside the solidified particles. The latter pores can be confirmed by, for example, analysis of an SEM image.

In the method of producing the solid spherical powder according to the present embodiment, the first powder raw material is preferably composed of a metal or an alloy having a melting point of 1,900° C. or higher. From the viewpoint of metals and alloys used industrially, the upper limit of the melting point is 3,500° C. In the present embodiment, it is possible to produce the spherical powder without droplets dissolved by the plasma flame touching the heat-resistant jig so much. Therefore, the metal or the alloy having a melting point of 1,900° C. or higher, which has been difficult in the conventional spherical powder production method in which a molten metal or a droplet touches a jig, can be selected as the first powder raw material.

In the method of producing the solid spherical powder according to the present embodiment, the metal or the alloy having a melting point of 1,900° C. or higher is preferably any one of Ir, Ru, an Ir-based alloy and a Ru-based alloy. Since the Ir, Ru, Ir-based alloy, and Ru-based alloy have high hardness, a solid spherical powder having a high melting point and high hardness can be produced. Preferred specific examples of the Ir-based alloy include Ir—Sc, Ir—Ti, Ir—Mn, Ir—Fe, Ir—Zr, Ir—Mo, Ir—Ru, Ir—Rh, Ir—Hf, Ir—W, Ir—Re, Ir—Pt, Ir—Re—Zr, and the like. Preferable specific examples of the Ru-based alloy include Ru—Cr, Ru—Mn, Ru—Fe, Ru—Co, Ru—Nb, Ru—Ir, Ru—Pt, Ru—Cr—Co, Ru—Cr—Mn, Ru—Mn—Co, and the like. In the present embodiment, the term “M-based alloy” (M represents a metal element such as Ir or Ru) refers to an alloy in which the content (mass %) of M is the highest among the elements constituting the alloy, and preferably refers to an alloy in which the content of M is 50 mass % or more.

In the method of producing the solid spherical powder according to the present embodiment, the first powder raw material preferably contains at least one of an electrolytic powder, a reduced powder, a mechanically alloyed powder, and a coated powder. In the step A, a hollow spherical powder having the surface layer shell having a thickness of 1 μm to 50 μm can have a particle diameter and porosity that are easy to produce, and therefore in the step B, a hollow spherical powder that is easy to pulverize can be easily produced. The definitions of the electrolytic powder, the reduced powder, the mechanically alloyed powder, and the coated powder are defined in JIS Z 2500: 2000 “Powder metallurgy-Vocabulary”.

The electrolytic powder is obtained by precipitating a powder on a negative electrode, preferably using an electrolytic method, and washing, dehydrating, and drying the powder.

The reduced powder is obtained by washing, dehydrating, and drying a generated powder preferably using a reduction method for oxide or a reduction method for chloride.

The mechanically alloyed powder is obtained by alloying a plurality of types of solid materials while pulverizing the solid materials preferably using a mechanical alloying method.

The particle of the coated powder has an inner portion and a surface layer covering the inner portion. Examples of the particle form of the inner portion include a form in which the inner portion is an agglomerated particle and/or a solidified particle, and a form in which the inner portion is a fine particle. In the case of the form in which the inner portion is the agglomerated particle and/or the solidified particle, the agglomerated particle and/or the solidified particle includes a surface layer covering the agglomerated particle itself and/or the solidified particle itself, and behaves as one particle without further agglomeration or solidification. In the case of the form in which the inner portion is the fine particle, the fine particle includes a surface layer covering the fine particle itself, and is agglomerated and/or solidified together with other fine particles including a surface layer similarly to this fine particle to form an agglomerated particle and/or a solidified particle. As the composition, the inner portion is composed of, for example, a metal or an alloy, and the surface layer is composed of, for example, a metal, an alloy, ceramics, or an organic substance. As a composition form of the inner portion and the surface layer, a combination of an inner portion and a surface layer, such as a combination of an inner portion composed of the metal and a surface layer composed of the metal, a combination of an inner portion composed of the metal and a surface layer composed of the alloy, a combination of an inner portion composed of the metal and a surface layer composed of the ceramics, a combination of an inner portion composed of the metal and a surface layer composed of the organic substance, a combination of an inner portion composed of the alloy and a surface layer composed of the metal, a combination of an inner portion composed of the alloy and a surface layer composed of the alloy, a combination of an inner portion composed of the alloy and a surface layer composed of the ceramics, and a combination of an inner portion composed of the alloy and a surface layer composed of the organic substance can be appropriately employed. When the combination of the inner portion and the surface layer is the combination of the inner portion composed of the metal and the surface layer composed of the metal, or the combination of the inner portion composed of the alloy and the surface layer composed of the alloy, the composition of the metal or the alloy is different between the inner portion and the surface layer. The coated powder is obtained by coating surfaces of exposed agglomerated particles and/or solidified particles or fine particles with the metal, the alloy, the ceramics, or the organic substance, preferably using a method of coating by spray coating, plating, sputtering, or concentration.

When the first powder raw material is introduced into the plasma flame, preferably, the same method as the method of producing spheroidized particles by the high-frequency plasma described in Patent Literature 2 is employed except that the supply direction of the first powder raw material is made the same as the flow direction of the plasma flame. In Patent Literature 2, it is essential that the first powder raw material is supplied countercurrently to the flow direction of the plasma flame in the high-frequency plasma reactor, but in this similar method, the supply direction of the first powder raw material is reversed. The particles of the first powder raw material preferably melt in a plasma flame to change into spherical droplets containing gas in the pores. The spherical droplets preferably solidify outside the plasma flame and change into hollow spherical powder particles each having a surface layer shell which has a thickness of 1 μm to 50 μm and a low porosity. The plasma gas is preferably mainly composed of Ar, and H₂, N₂, and/or O₂ is added thereto depending on the situation. The plasma flame is preferably generated by applying a high-frequency current through a high-frequency coil of a plasma generator. In this improvement method, the thickness of the surface layer shell of the hollow spherical powder can be controlled by adjusting the component of the first powder raw material, the particle diameter of the first powder raw material, the porosity of the particles of the first powder raw material, the carrier gas flow rate used for supplying the first powder raw material, and the plasma output, and the component of the plasma gas. Here, the porosity of the particles of the first powder raw material refers to the volume ratio of pores in the entire particles of the first powder raw material. The porosity can be confirmed by, for example, analysis of an SEM image.

The term “hollow spherical powder” refers to a powder containing a particle which has a surface layer shell covering outside and has a void inside (hereinafter, referred to as hollow spherical particle), and in which the entire surface of the surface layer shell forms an outwardly convex curved surface. The shape of the particles of the hollow spherical powder is, for example, a sphere or an ellipsoid. The hollow spherical particle does not have cracks, protrusions, and recesses on the surface layer shell. The hollow spherical powder may include a particle having a crack on a surface layer shell thereof, a particle having a protrusion on a surface layer shell thereof, and a particle having a recess on a surface layer shell thereof. Examples of the particle having a protrusion on the surface layer shell include particles in which the first powder material having protrusions does not change into spherical droplets and the shape of the first powder material is maintained in the plasma flame in the step A. In the hollow spherical powder of the present embodiment, when at least 100 particles of the hollow spherical powder are set in all in a field of view of a SEM, the proportion of particles whose surface forms an outwardly convex curved surface, which do not have protrusions or recesses, and whose “circularity” as shown in Equation 1 is in a range of 0.5 to 1 (hereinafter, also referred to as spherical particles) in all particles of the hollow spherical powder in the field of view of the SEM is preferably 50% or more, and when at least 10 cross sections of particles of the hollow spherical powder are set in all in a field of view of an optical microscope (OM), the proportion of particles which have a surface layer shell covering outside and have a void inside (hereinafter, also referred to as hollow particles) in all particles of the hollow spherical powder in the field of view of the optical microscope is preferably 50% or more. Each of both proportions is more preferably 70%, and still more preferably 90%. When the proportion of the spherical particles and/or the proportion of the hollow particles is less than 50%, there is a possibility that the pulverization treatment becomes difficult in the step B. All the particles of the hollow spherical powder can be evaluated by an SEM image, image analysis software, and an optical microscope image. In Equation 1, S is an area of a particle, and P is a circumferential length of the particle. The circularity is 1 in the case of a perfect circle.

$$Circularity = 4 π S / {P}^{2} \qquad [ Equation 1 ]$$

The thickness of the surface layer shell of the hollow spherical powder is 1 μm to 50 μm. The thickness is more preferably 1 μm to 30 μm, and still more preferably 5 μm to 20 μm. When the thickness is less than 1 μm, the volume of the second powder raw material obtained in the step B is reduced. As a result, in the step C, a solid spherical powder having a particle diameter smaller than a desired particle diameter is generated, and/or particles of the solid spherical powder are agglomerated with each other. When the thickness exceeds 50 μm, the strength of the surface layer shell increases, making it difficult to perform pulverization treatment of the hollow spherical powder. In addition, the volume of the second powder raw material obtained in the step B increases. As a result, a large number of hollow spherical particles may remain in the solid spherical powder after the step C, or a solid spherical powder having a particle diameter larger than a desired particle diameter may be generated. The thickness of the surface layer shell can be measured, for example, by observing cross sections of particles of the powder with an optical microscope. In addition, the thickness of the surface layer shell can be confirmed even with a particle whose surface layer shell is cracked. Note that even a particle whose surface layer shell is cracked can be supplied to the next step B.

The particle size distribution of the hollow spherical powder is preferably D10≥10 μm and D90≤1,000 μm on a volume basis, more preferably D10≥30 μm and D90≤600 μm, and still more preferably D10≥50 μm and D90≤200 μm. The particle size of the hollow spherical powder depends on the particle size of the first powder raw material. The particle size distribution of the hollow spherical powder can be measured by, for example, a particle size distribution measuring apparatus.

<Step B>

In the step B, the hollow shape of the hollow spherical powder is pulverized. Since the hollow spherical powder is formed through melting and solidification, it is considered that the surface layer shell has a low porosity and a high relative density. Since the second powder raw material is a powder raw material obtained by pulverizing the surface layer shell, the relative density of the surface layer shell can be maintained.

In the method of producing the solid spherical powder according to the present embodiment, the pulverization treatment of the hollow spherical powder is preferably impact pulverization. The impact pulverization can efficiently pulverize even micron-order particles, so that the hollow spherical powder can be made fine to obtain a second powder raw material having an adjusted particle size. The material of the jig used for impact pulverization is preferably a material that is not mixed due to scraping of the jig, and examples thereof include agate, zirconia, and the like.

The particle size distribution of the second powder raw material is preferably D10≥10 μm and D90≤900 μm on a volume basis, more preferably D10≥25 μm and D90≤500 μm, and still more preferably D10≥40 μm and D90≤180 μm. The particle size distribution of the second powder raw material depends on the form of the pulverization treatment. By adjusting the particle size of the second powder raw material, a solid spherical powder having a desired particle size can be produced. The particle size distribution of the second powder raw material can be measured by, for example, a particle size distribution measuring apparatus.

<Step C>

In the step C, preferably, the same method as the method of producing spheroidized particles by the high-frequency plasma described in Patent Literature 2 is employed except that the supply direction of the second powder raw material is made the same as the flow direction of the plasma flame. The particles of the second powder raw material preferably melt in the plasma flame to change into spherical droplets. The spherical droplets preferably solidify outside the plasma flame and change into solid spherical powder particles. The plasma gas is preferably mainly composed of Ar, and H₂, N₂, and/or O₂ is added thereto depending on the situation. The plasma flame is preferably generated by applying a high-frequency current through a high-frequency coil of a plasma generator. In this improvement method, when the second powder raw material having a low porosity is melted, the gas does not enter the spherical droplets, so that the solid spherical powder can be produced.

In the present embodiment, the term “solid spherical powder” refers to a powder containing a particle which has no void inside and whose entire surface forms an outwardly convex curved surface (hereinafter, referred to as solid spherical particle). The shape of the solid spherical powder is, for example, a sphere or an ellipsoid. The solid spherical particle does not have hiatuses, protrusions and recesses. The solid spherical powder may include a particle having a hiatus on a surface thereof, a particle having a protrusion on a surface thereof, and a particle having a recess on a surface thereof. Examples of the particle having a protrusion on the surface layer shell include particles in which the second powder material having protrusions does not change into spherical droplets and the shape of the second powder material is maintained in the plasma flame in the step C. In the solid spherical powder of the present embodiment, when at least 100 particles of the solid spherical powder are set in all in a field of view of a SEM, the proportion of spherical particles in all particles of the solid spherical powder in the field of view of the SEM is preferably 80% or more, and when at least 100 cross sections of particles of the solid spherical powder are set in all in a field of view of an optical microscope, the proportion of particles having no void inside (hereinafter, also referred to as solid particles) in all particles of the solid spherical powder in the field of view of the optical microscope is preferably 80% or more. Each of both proportions is more preferably 90% or more, and still more preferably 95% or more. When the proportion of the spherical particles is less than 80%, the flowability of the powder decreases, and there is a possibility that the superiority derived from the spherical shape cannot be exhibited. When the proportion of the solid particles is less than 80%, there is a possibility that a raw material of a shaped product having a high relative density cannot be obtained. All the particles of the solid spherical powder can be evaluated by an SEM image, image analysis software, and an optical microscope image.

The particle size of the solid spherical powder depends on the particle size of the second powder raw material. The particle size distribution of the solid spherical powder can be measured by, for example, a particle size distribution measuring apparatus.

<Step D and Step E>

The method of producing the solid spherical powder according to the present embodiment preferably further includes a step D of classifying the second powder raw material and/or a step E of classifying the solid spherical powder. The form of the production method further including the step D and/or the step E is a form of a production method including the step A, the step B, the step D, and the step C, a form of a production method including the step A, the step B, the step C, and the step E, or a form of a production method including the step A, the step B, the step D, the step C, and the step E. The classification can narrow the particle size distribution constituting the second powder raw material, can make it easier to form a solid spherical powder having a desired particle size, and can further enhance the flowability of the solid spherical powder. The range of suitable particle diameter of the solid spherical powder varies depending on the application, and is generally 45 to 105 μm in the case of the EBM application, 10 to 45 μm in the case of the SLM application, 45 to 105 μm in the case of the LMD application, and 200 to 300 μm in the case of the medical application. In the present embodiment, even if the range of the suitable particle diameter of the solid spherical powder has a width wider than the width of the general range in each of these applications, the solid spherical powder can be used for each application.

In the method of producing the solid spherical powder according to the present embodiment, an apparent density of the solid spherical powder defined in JIS Z 2504: 2012 “Metallic powders-Determination of apparent density” is preferably 50% or more with respect to a true density thereof. The reason for the low apparent density is low flowability due to the low circularity as shown in Equation 1 and presence of intraparticle pores. The low flowability is a factor that makes the powder supply unstable in the additive manufacturing process, and the presence of intraparticle pores is a factor that causes pores to remain inside the shaped product. For these reasons, when the apparent density is less than 50% with respect to the true density, there is a possibility that a raw material of a shaped product having a high relative density cannot be obtained.

The impurity ratio in the solid spherical powder produced by the method of producing the solid spherical powder according to the present embodiment is preferably 1 mass % or less. The impurity ratio is more preferably 0.1 mass % or less, and still more preferably 0.05 mass % or less. When the impurity ratio increases, the optimum range (process window) of the production conditions changes, so that it becomes difficult to control the production of a high-quality shaped product. In addition, impurities contribute to the occurrence of internal defects and cracks, and there is a possibility that a raw material of a shaped product having a high relative density cannot be obtained. Here, the term “impurities” refer to substances mixed in steps A to E, such as fragments of the jig used in the pulverization treatment. The lower limit of the impurity ratio is 0.0001 mass % from the viewpoint of measurement accuracy. The impurity ratio can be measured, for example, by comparison between elemental analysis of the first powder raw material and elemental analysis of the solid spherical powder.

The oxygen content in the solid spherical powder produced by the method of producing the solid spherical powder according to the present embodiment is preferably 0.1 mass % or less. When the oxygen content exceeds 0.1 mass %, oxidization occurs, and there is a possibility that a raw material of a high-quality shaped product cannot be obtained. The oxygen content can be measured, for example, by gas analysis of a solid spherical powder.

A method of producing a shaped product according to the present embodiment is a method of producing a shaped product, wherein in an additive manufacturing method including a step of laminating layers obtained by at least partially melting and solidifying a powder to be irradiated by high-energy irradiation to form the shaped product, the powder to be irradiated is the solid spherical powder produced by the method of producing the solid spherical powder according to the present embodiment. In the present embodiment, even a metal or an alloy having a high melting point and being difficult to process can be used to produce a shaped product, and thus a solid spherical powder composed of the metal or the alloy which has a high melting point and is difficult to process can be selected as the powder to be irradiated.

Examples of the form of the additive manufacturing method include forms of known additive manufacturing methods such as EBM, SLM, and LMD. When a highly flowable solid spherical powder made of a high-melting point and difficult-to-process metal is used as a material for additive manufacturing, a shaped product having a high relative density can be produced.

In the method of producing the shaped product of the present embodiment, a relative density of the shaped product is preferably 99% or more. When the relative density is less than 99%, there is a possibility that the quality required for the shaped product is not satisfied. Preferable specific examples of the shaped product include shaped products having a complicated shape, such as an electrode, a processing tool, and a crucible for μ-PD method. The relative density can be measured, for example, by the in-liquid weighing method described in JIS Z 8807: 2012 “Methods of measuring density and specific gravity of solid”.

### EXAMPLES

Hereinafter, the present invention will be described in more detail with reference to examples, but the present invention is not construed as being limited to the examples.

<Particle Size Distribution of First Powder Raw Material>

A particle size distribution of a first powder raw material was measured by laser diffraction using a particle size distribution measuring apparatus (Laser Micron Sizer LMS-30, manufactured by Seishin Enterprise Co., Ltd.). A particle diameter (D10) corresponding to 10% of the cumulative particle size distribution measured on a volume basis and a particle diameter (D90) corresponding to 90% thereof were read, and a section between these points was used as an index of a particle size of the first powder raw material.

<Porosity of Particles of First Powder Raw Material>

The particles of the first powder raw material were observed with an SEM, and the observed SEM image was analyzed with image analysis software (Quick Grain, manufactured by Innotech Corporation) to confirm porosity of the particles. Specifically, the contrast of the SEM image was enhanced and binarization of black and white was performed, and then a proportion of a region where no powder was present to the entire region was derived and taken as a porosity.

<Elemental Analysis>

Elemental analysis was performed by glow discharge mass spectrometry (GDMS) using a glow discharge mass spectrometer (ELEMENT GD, manufactured by Thermo Fisher Scientific, Inc.).

<Proportion of Spherical Particles in all Particles of Hollow Spherical Powder in Field of View of SEM>

Using the SEM, at least 100 particles of a hollow spherical powder were set in all in a field of view of the SEM, and the number of all particles of the hollow spherical powder in the field of view and the number of spherical particles among all the particles were counted with image analysis software to determine a proportion.

<Proportion of Hollow Particles in all Particles of Hollow Spherical Powder in Field of View of Optical Microscope and Thickness of Surface Layer Shell of Hollow Spherical Powder>

The hollow spherical powder was solidified with a transparent resin (Aron Alpha (registered trademark)) and polished with #800 abrasive paper until cross sections of the hollow spherical powder was visible. Using an optical microscope (GX51, manufactured by Olympus Corporation), at least 10 cross sections of particles of the hollow spherical powder were set in all in a field of view of the optical microscope, and the number of all particles of the hollow spherical powder in the field of view and the number of hollow particles among all the particles were counted to determine a proportion of hollow particles in all the particles of the hollow spherical powder. In addition, thicknesses of the surface layer shells of all the hollow spherical particles present in the field of view were measured, an average value was calculated, and this was used as a thickness of the surface layer shell of the hollow spherical powder.

<Particle Size Distribution of Hollow Spherical Powder>

A particle size distribution of the hollow spherical powder was measured using the particle size distribution measuring apparatus. A particle diameter (D10) corresponding to 10% of the cumulative particle size distribution measured on a volume basis and a particle diameter (D90) corresponding to 90% were read, and a section between these points were used as an index of a particle size of the hollow spherical powder.

<Particle Size Distribution of Second Powder Raw Material>

A particle size distribution of a second powder raw material was measured using the particle size distribution measuring apparatus. D10 and D90 in the cumulative particle size distribution measured on a volume basis were read, and a section between these points was used as an index of a particle size of the second powder raw material.

<Proportion of Spherical Particles in all Particles of Solid Spherical Powder in Field of View of SEM>

Using the SEM, at least 100 particles of the solid spherical powder were set in all in a field of view of the SEM, and the number of all particles of the solid spherical powder in the field of view and the number of spherical particles among all the particles were counted to determine a proportion.

<Proportion of Solid Particles in all Particles of Solid Spherical Powder in Field of View of Optical Microscope>

The solid spherical powder was solidified and polished until cross sections of the solid spherical powder was visible in the same manner as when the proportion of the cross sections of hollow particles in the cross sections of all particles in the hollow spherical powder in the field of view of the optical microscope was measured. At least 100 cross sections of particles of the solid spherical powder were set in all in a field of view of the optical microscope, and the number of all particles of the solid spherical powder in the field of view and the number of solid particles among all the particles were counted with image analysis software to determine a proportion.

<Proportion of Solid Spherical Particles in all Particles of Solid Spherical Powder>

The proportion was determined by multiplying the proportion of the spherical particles in all particles of the solid spherical powder in the field of view of the SEM by the proportion of the solid particles in all particles of the solid spherical powder in the field of view of the optical microscope.

<Particle Size Distribution of Solid Spherical Powder>

A particle size distribution of the solid spherical powder was measured using the particle size distribution measuring apparatus. D10 and D90 in the cumulative particle size distribution measured on a volume basis were read, and a section between these points was used as an index of a particle size of the solid spherical powder.

<Apparent Density of Solid Spherical Powder>

With reference to the definition of JIS Z 2504: 2012 “Metallic powders-Determination of apparent density”, in accordance with the method of JIS Z 2512: 2012 “Metallic powders-Determination of tap density”, the solid spherical powder was weighed at 100±0.5 g using a measurement container (Measuring cylinder Custom A, volume 25 mL, manufactured by Sibata Scientific Technology Ltd.) graduated to a capacity of 25 cm³ for every 0.2 cm³, the powder was then placed in the measurement container from the edge of the measurement container, a surface layer portion was leveled by a method in which vibration did not occur and the sample was not pressed, and a volume was directly read on the scale of the measurement container.

<Elemental Analysis of Solid Spherical Powder>

Elemental analysis of the solid spherical powder was performed using the glow discharge mass spectrometer.

<Calculation of Yield>

{(Mass of solid spherical powder having desired particle size)/(mass of the charged feedstock)}×100 (unit: %) was defined as a yield. Here, the feedstock is the first raw material powder, a wire, or a round bar. In order to obtain the mass value of the solid spherical powder having a desired particle size, a method of measuring the mass of the solid spherical powder with an electronic balance after classification and/or a method of deriving from a proportion on a volume basis of particle size distribution measurement was employed. The particle size distribution measurement was based on volume, but in the present Examples and Comparative Examples, the yield on a volume basis and the yield on a mass basis were the same considering that the solid spherical powder was sufficiently dense (solid).

<Relative Density of Shaped Product>

A relative density of a shaped product was measured using a balance and a specific gravity measurement kit for an XP/XS balance (manufactured by Mettler-Toledo International Inc.) based on the in-liquid weighing method described in JIS Z 8807.

### Example 1

<Step A>

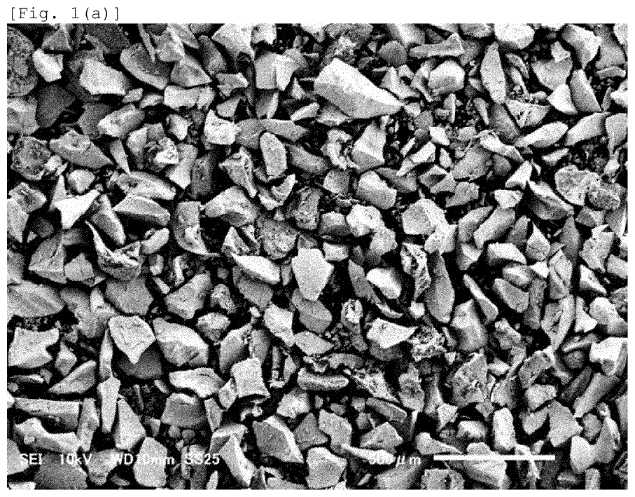

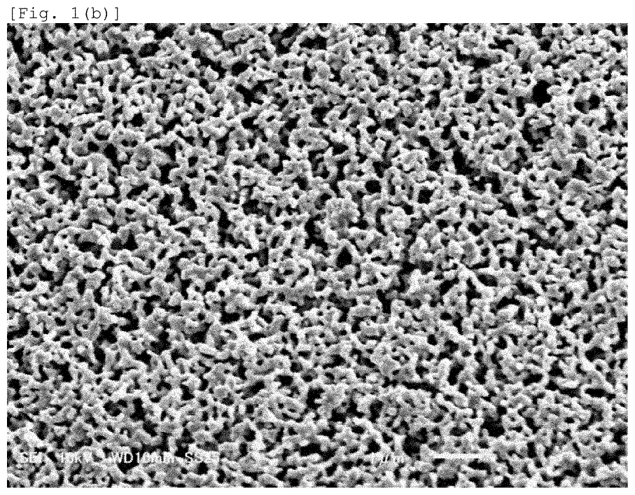

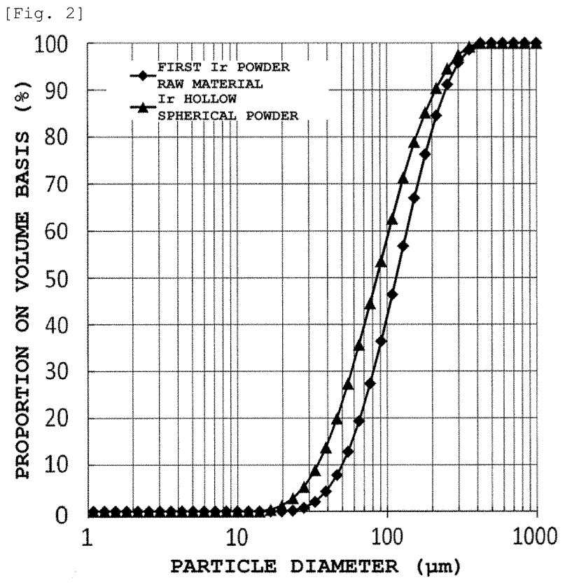

A first Ir powder raw material (refined powder, manufactured by Furuya Metal Co., Ltd.) containing agglomerated particles and/or solidified particles of Ir porous bodies, which have a particle diameter of 1 μm to 1,000 μm, was prepared. SEM images of the first Ir powder raw material were confirmed. FIG. 1(a) shows a low-magnification SEM image in a field of view of 2,000×2,500 μm, and FIG. 1(b) shows a high-magnification SEM image in a field of view of 9×12 μm. From FIG. 1(a), it was confirmed that the particle diameter of the first Ir powder raw material was 1 μm or more and 1,000 μm or less, and from FIG. 1(b), pores were confirmed in the particles of the first Ir powder raw material. The porosity of the particles of the first Ir powder raw material was calculated by analysis of the SEM image of FIG. 1(b). The porosity was 43.39%. The particle size distribution of the first Ir powder raw material was measured using the particle size distribution measuring apparatus. FIG. 2 shows a graph of the cumulative particle size distribution. As a result of the measurement, in the particle size distribution of the first Ir powder raw material, D10 was 50.0 μm, and D90 was 244.7 μm. Elemental analysis of the first Ir powder raw material was performed using the glow discharge mass spectrometer. The total content of impurities was 0.0064 mass %.

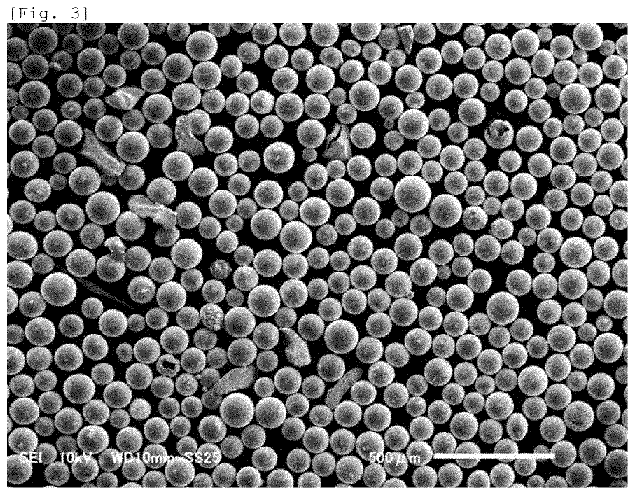

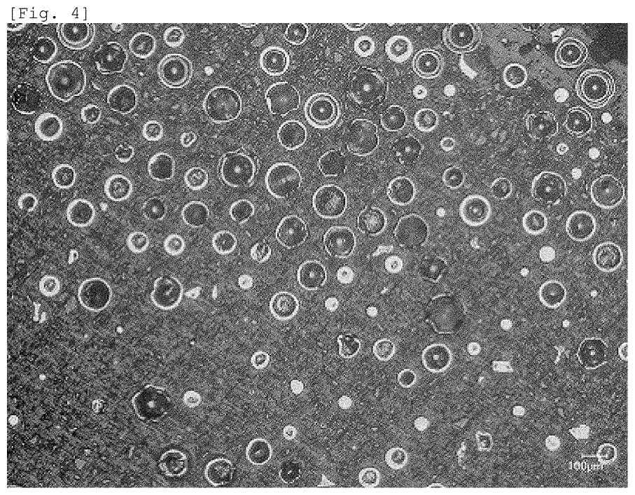

The same method as the method of producing spheroidized particles by high-frequency plasma described in Patent Literature 2 was employed except that the supply direction of the first Ir powder raw material was made the same as the flow direction of the plasma flame. In the powder supply type high-frequency plasma reactor, the supply amount of the first Ir powder raw material was set to 6 g/min, the carrier gas flow rate was set to 5 L/min, the high frequency plasma gas was a mixed gas obtained by adding N₂ to Ar, the plasma output was set to 33.3 kW, and the first Ir powder raw material was introduced into a plasma flame to produce an Ir hollow spherical powder. FIG. 3 shows an SEM image of the Ir hollow spherical powder. FIG. 4 shows an optical microscope image of cross sections of the Ir hollow spherical powder. FIG. 2 shows a graph of the cumulative particle size distribution of the Ir hollow spherical powder. In FIG. 3, the proportion of spherical particles in all particles of the obtained Ir hollow spherical powder was 95% or more. In FIG. 4, the proportion of hollow particles in all particles of the obtained Ir hollow spherical powder was 75% or more. The range of the thickness of the surface layer shell was 5 μm to 25 μm, and the average thickness of the surface layer shell was 15 μm. In the particle size distribution, D10 was 34.3 μm, and D90 was 210.0 μm. The content of Si contained in the Ir hollow spherical powder was measured by GDMS using the glow discharge mass spectrometer. As a result of the measurement, the content of Si as an impurity was 0.0003 mass %.

<Step B and Step D>

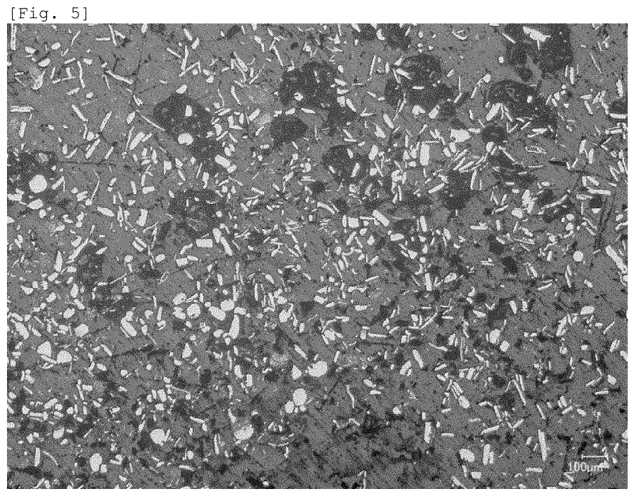

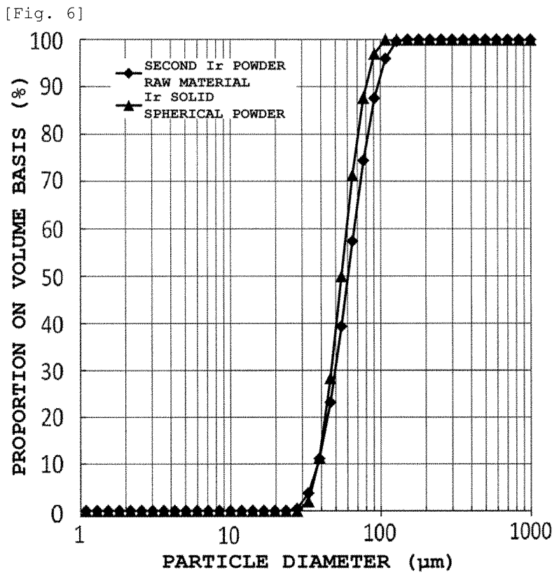

In a planetary mill container made of agate, the Ir hollow spherical powder was placed so that the volume of the powder was 10 or less when the volume of the container is 100, 100 agate balls having a ball diameter of 10 mm were placed therein, pulverization was then performed for 1 hour under the condition of 200 rpm using a planetary rotating ball mill (LP-4, manufactured by Ito Seisakusho. Co., Ltd.) to pulverize the hollow shape of the hollow spherical powder, thus obtaining a second Ir powder raw material. Thereafter, the second Ir powder raw material was classified using a metal sieve having a mesh size of 38 μm and a metal sieve having a mesh size of 63 μm so that a suitable range of a particle diameter of the second Ir powder raw material was more than 38 μm and 63 μm or less. FIG. 5 shows an optical microscope image of cross sections of the second Ir powder raw material after classification. FIG. 6 shows a graph of the cumulative particle size distribution of the second Ir powder raw material after classification. As a result of the measurement, in the particle size distribution, D10 was 38.1 μm, and D90 was 94.7 μm. In order to confirm an influence of Si mainly contained in the agate ball, the content of Si contained in the second Ir powder raw material was measured by GDMS using the glow discharge mass spectrometer. As a result of the measurement, it was confirmed that the content of Si as an impurity was 0.0026 mass %, and the increase in the content of Si contained in the second Ir powder raw material due to the agate ball was suppressed to a slight increase.

<Step C and Step E>

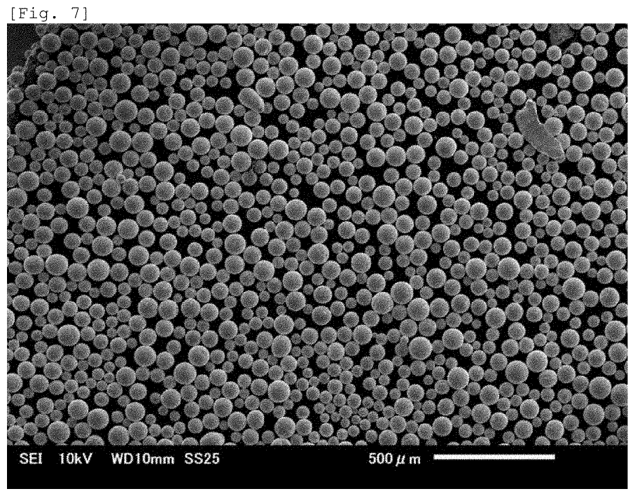

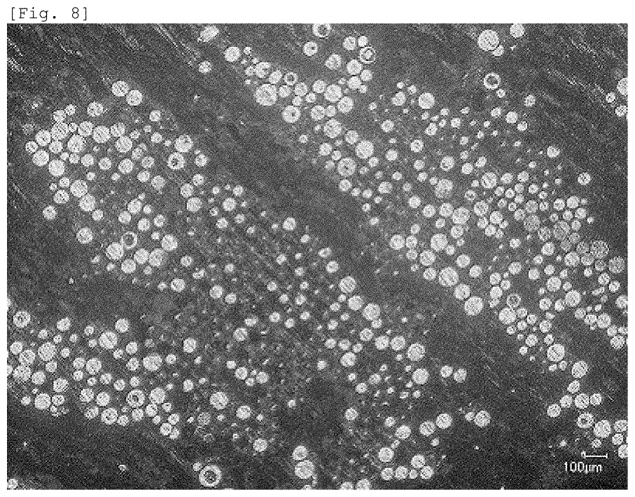

The same method as the method of producing spheroidized particles by high-frequency plasma described in Patent Literature 2 was employed except that the supply direction of the second Ir powder raw material after classification was made the same as the flow direction of the plasma flame. In the powder supply type high-frequency plasma reactor, the supply amount of the second Ir powder raw material after classification was set to 6 g/min, the carrier gas flow rate was set to 5 L/min, the high frequency plasma gas was a mixed gas obtained by adding N₂ to Ar, the voltage of the plasma output was set to 33.3 kW, and the second Ir powder raw material was introduced into a plasma flame to produce an Ir solid spherical powder. Thereafter, the Ir solid spherical powder was classified using a metal sieve having a mesh size of 22 μm and a metal sieve having a mesh size of 63 μm so that the suitable range of the particle diameter was more than 22 μm and 63 μm or less, thus obtaining an intended Ir solid spherical powder. FIG. 7 shows an SEM image of the Ir solid spherical powder after classification, and FIG. 8 shows an optical microscope image of cross sections of the Ir solid spherical powder after classification. In addition, FIG. 6 shows a graph of the cumulative particle size distribution of the Ir solid spherical powder after classification. In FIG. 7, the proportion of spherical particles in all particles of the obtained Ir solid spherical powder was 99% or more. In FIG. 8, the proportion of solid particles was 94% or more. In calculation, the proportion of solid spherical particles in all particles of the obtained Ir solid spherical powder is 99×0.94=93.06% or more. In the particle size distribution, D10 was 38.2 μm, and D90 was 79.2 μm. The apparent density was 13.16 g/cm³, which was 58.3% with respect to the true density. The contents of all elements contained in the Ir solid spherical powder were measured by GDMS using the glow discharge mass spectrometer. As a result of the measurement, the content of impurities was 0.0331 mass %. Therefore, the impurity ratio was 0.0267 mass % from {(content of impurity in Ir solid spherical powder)-(content of impurity in first Ir powder raw material)}. In addition, an oxygen content measured by a gas analyzer (TS600, manufactured by LECO Corporation) was less than 0.0014 mass % of the quantitative lower limit. The Ir solid spherical powder of Example 1 obtained by classification can be used for SLM, and as a result of mass measurement, the yield was 79.5%. When the cumulative particle size distribution was confirmed for reference, since the proportion of the solid spherical powder having a particle diameter of 10 μm to 45 μm in the Ir solid spherical powder obtained by classification was about 28% on a volume basis, the yield of the solid spherical powder having a particle diameter of 10 μm to 45 μm suitable for SLM was 79.5×0.28≈22% on a volume basis.

<Production of Shaped Product>

Using the Ir solid spherical powder, a cylindrical shaped product having a size of φ3.8×19 mm was produced by an SLM apparatus (SLM280HL, manufactured by SLM). Thereafter, an outer surface thereof was adjusted by grinding processing to obtain a shaped product having a size of φ3.6×18.6 mm, and the relative density of the shaped product was measured by the in-liquid weighing method using the specific gravity measurement kit for an XP/XS balance. The relative density of this shaped product was 99.5%.

### Example 2

<Step A>

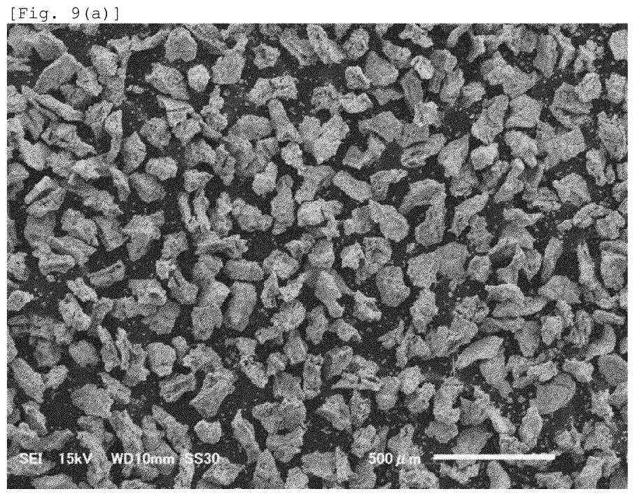

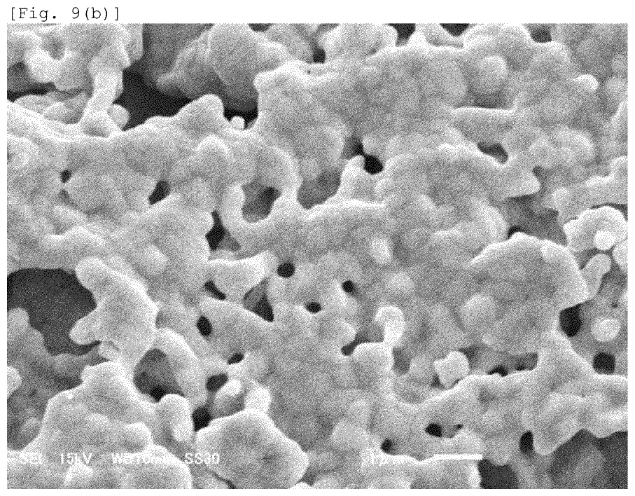

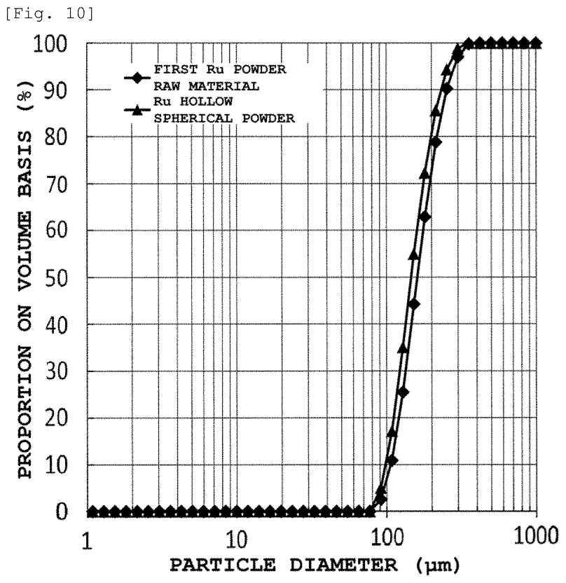

In Example 2, the same operation as in Example 1 was performed except that the shaped product was not produced. A first Ru powder raw material (refined powder, manufactured by Furuya Metal Co., Ltd.) containing agglomerated particles and/or solidified particles of Ru porous bodies, which have a particle diameter of 1 μm to 1,000 μm, was prepared. SEM images of the first Ru powder raw material was confirmed. FIG. 9(a) shows a low-magnification SEM image in a field of view of 2,000×2,500 μm, and FIG. 9(b) shows a high-magnification SEM image in a field of view of 9×12 μm. From the SEM image of FIG. 9(a), it was confirmed that the particle diameter of the first Ru powder raw material was 1 μm or more and 1,000 μm or less, and from the SEM image of FIG. 9(b), pores were confirmed in the particles of the first Ru powder raw material. The porosity of the particles of the first Ru powder raw material was calculated in the same manner as in Example 1 by analysis of the SEM image of FIG. 9(b). The porosity was 20.27%. The particle size distribution of the first Ru powder raw material was measured using the particle size distribution measuring apparatus. FIG. 10 shows a graph of the cumulative particle size distribution. As a result of the measurement, in the particle size distribution of the first Ru powder raw material, D10 was 106.5 μm, and D90 was 252.1 μm. Elemental analysis of the first Ru powder raw material was performed in the same manner as in Example 1. The total content of impurities was 0.0138 mass %.

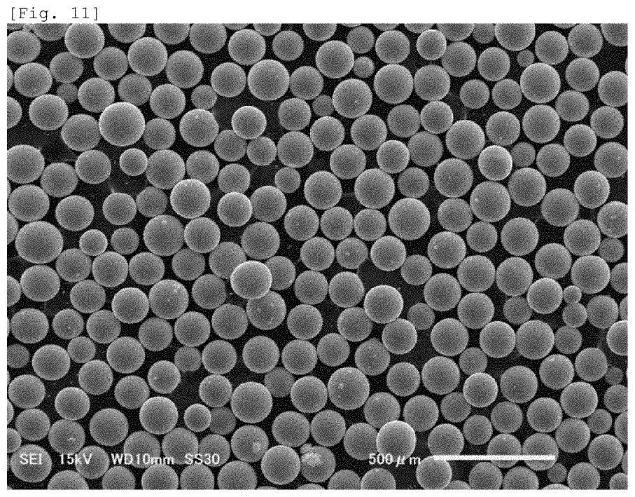

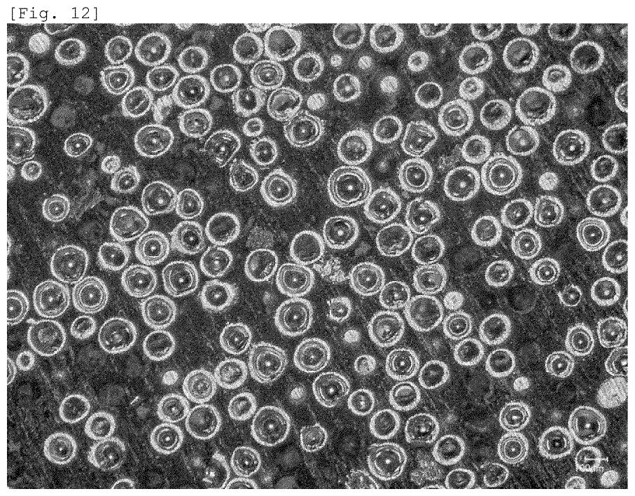

Next, a Ru hollow spherical powder was produced in the same manner as in Example 1 except that the first Ir powder raw material was changed to the first Ru powder raw material, the supply amount of the first Ru powder raw material was set to 8 g/min, the carrier gas flow rate was set to 10 L/min, the high-frequency plasma gas was a mixed gas obtained by adding H₂ to Ar, and the plasma output was set to 29.0 kW. FIG. 11 shows an SEM image of the Ru hollow spherical powder. FIG. 12 shows an optical microscope image of cross sections of the Ru hollow spherical powder. FIG. 10 shows a graph of the cumulative particle size distribution of the Ru hollow spherical powder. In FIG. 11, the proportion of spherical particles in all particles of the obtained Ru hollow spherical powder was 99% or more. In FIG. 12, the proportion of hollow particles in all particles of the obtained Ru hollow spherical powder was 85% or more. The range of the thickness of the surface layer shell was 10 μm to 30 μm, and the average thickness of the surface layer shell was 20 μm. In the particle size distribution, D10 was 99.0 μm, and D90 was 230.0 μm. In the same manner as in Example 1, the content of Si contained in the Ru hollow spherical powder was measured. As a result of the measurement, the content of Si as an impurity was 0.0013 mass %.

<Step B and Step D>

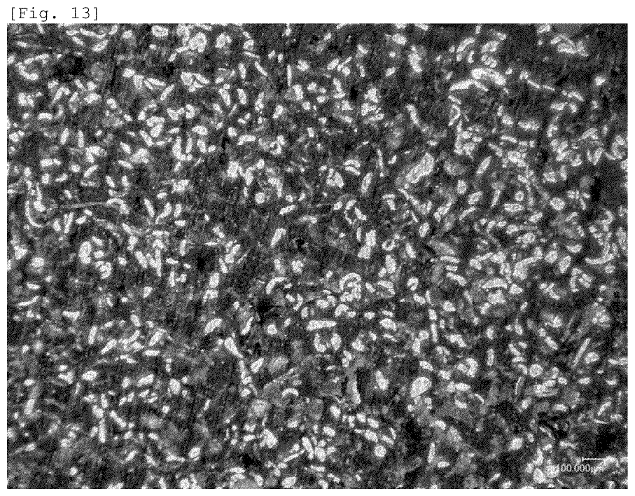

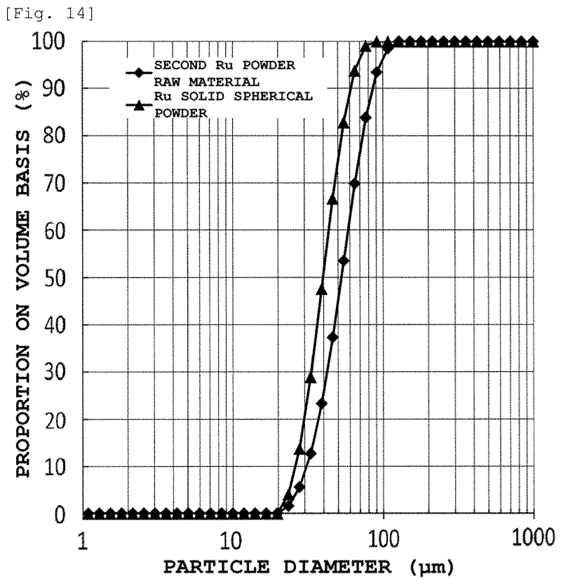

A second Ru powder raw material was obtained in the same manner as in Example 1 except that the second Ir hollow spherical powder was changed to a second Ru hollow spherical powder. Thereafter, the second Ru powder raw material was classified using a metal sieve having a mesh size of 22 μm and a metal sieve having a mesh size of 63 μm so that a suitable range of a particle diameter of the second Ru powder raw material was more than 22 μm and 63 μm or less. FIG. 13 shows an optical microscope image of the second Ru powder raw material after classification. FIG. 14 shows a graph of the cumulative particle size distribution of the pulverized powder of the second Ru powder raw material after classification. As a result of the measurement, D10 was 31.0 μm, and D90 was 84.8 μm. In the same manner as in Example 1, the content of Si contained in the second Ru powder raw material was measured. As a result of the measurement, it was confirmed that the content of Si as an impurity was 0.0620 mass %, and an increase in the content of Si contained in the second Ru powder raw material due to the agate ball was suppressed to a slight increase.

<Step C and Step E>

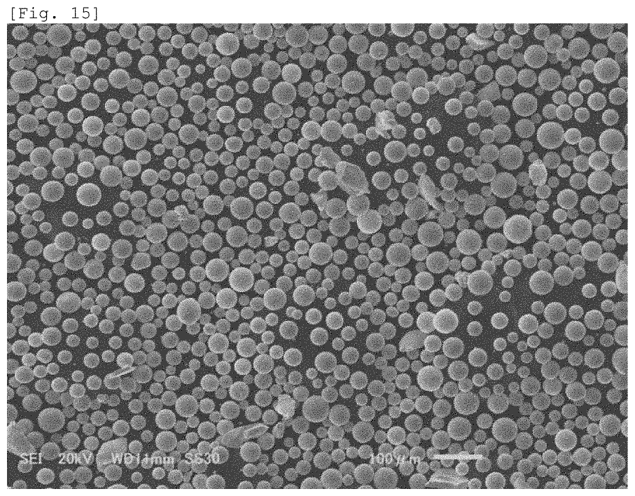

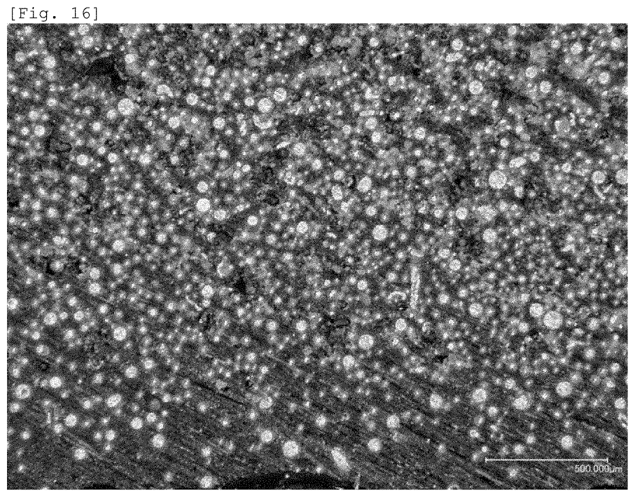

A Ru solid spherical powder was produced in the same manner as in Example 1 except that the second Ir powder raw material after classification was changed to a second Ru powder raw material after classification, the supply amount of the second Ru powder raw material after classification was set to 8 g/min, the carrier gas flow rate was set to 10 L/min, the high-frequency plasma gas was a mixed gas obtained by adding H₂ to Ar, and the voltage of the plasma output was set to 29.0 kW. Thereafter, the Ru solid spherical powder was classified in the same manner as in Example 1 to obtain an intended Ru solid spherical powder. FIG. 15 shows an SEM image of the Ru solid spherical powder after classification, and FIG. 16 shows an optical microscope image of cross sections of the Ru solid spherical powder after classification. FIG. 14 shows a graph of the cumulative particle size distribution of the Ru solid spherical powder after classification. In FIG. 15, the proportion of spherical particles in all particles of the obtained Ru solid spherical powder was at least 95% or more. In FIG. 16, the proportion of solid particles in all particles of the obtained Ru solid spherical powder was 99% or more. In calculation, the proportion of solid spherical particles in all particles of the obtained Ru solid spherical powder is 95×0.99=94.05% or more. In the particle size distribution, D10 was 26.2 μm, and D90 was 60.4 μm. The apparent density was 7.30 g/cm³, which was 58.6% with respect to the true density. As a result of the measurement, the content of impurities was 0.0152 mass %. Therefore, when calculated in the same manner as in Example 1, the impurity ratio was 0.0014 mass %. In addition, the oxygen content measured by the gas analyzer was 0.0065 mass %. In the same manner as in Example 1, the yield of the Ru solid spherical powder obtained by classification was derived, and the yield was 86.9%. When the cumulative particle size distribution was confirmed, since the proportion of the Ru solid spherical powder having a particle diameter of 10 μm to 45 μm in the Ru solid spherical powder obtained by classification was about 67% on a volume basis, the yield of the Ru solid spherical powder having a particle diameter of 10 μm to 45 μm suitable for SLM was 86.9×0.67≈58% on a volume basis.

### Comparative Example 1

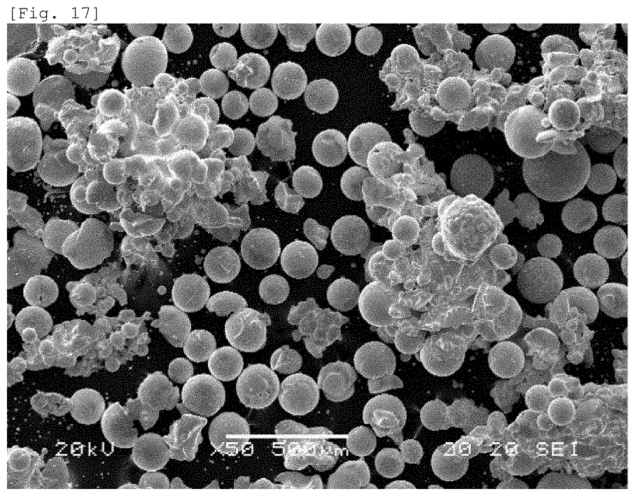

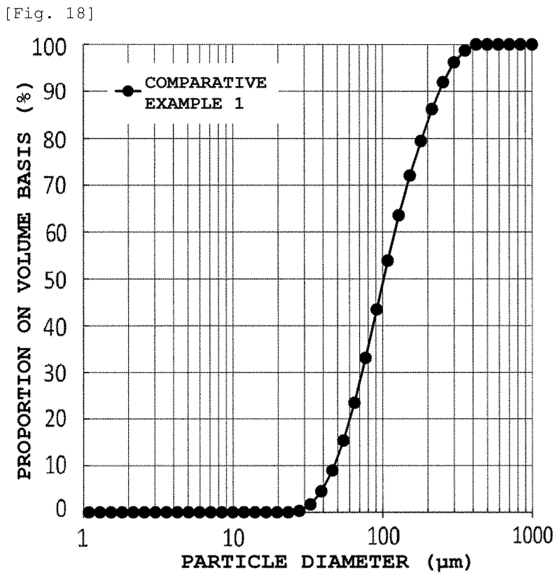

An Ir wire having a size of φ1.2 mm and 3.4 m length was prepared. An Ir solid spherical powder was produced using this Ir wire. Specifically, the Ir solid spherical powder was produced by supplying the wire to a wire supply type plasma atomization apparatus without producing and pulverizing a hollow spherical powder. From mass measurement, 91% of the charged Ir wire turned into the Ir solid spherical powder, and 9% volatilized and disappeared. FIG. 17 shows an SEM image of the Ir solid spherical powder. FIG. 18 shows a graph of the cumulative particle size distribution. In the SEM image of the obtained Ir solid spherical powder, a spherical powder was confirmed, and aggregates of powder particles was partially confirmed. As a result of the measurement, in the particle size distribution, D10 was 47.6 μm, and D90 was 237.6 μm, and the powder exhibited a wide particle size distribution. Further, from the cumulative particle size distribution, the proportion of the Ir solid spherical powder having a particle diameter of 10 μm to 45 μm was about 9% on a volume basis. Therefore, the yield of the Ir solid spherical powder having a particle diameter of 10 μm to 45 μm suitable for SLM was 91×0.09≈8% on a volume basis. Due to poor yield, the method of producing the Ir solid spherical powder was not suitable for a material for SLM.

### Comparative Example 2

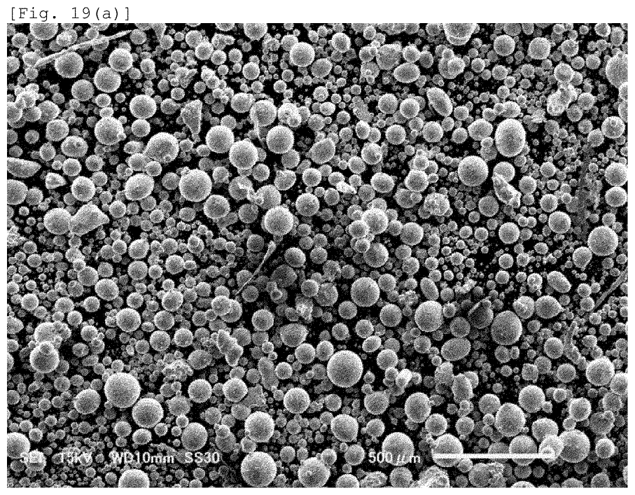

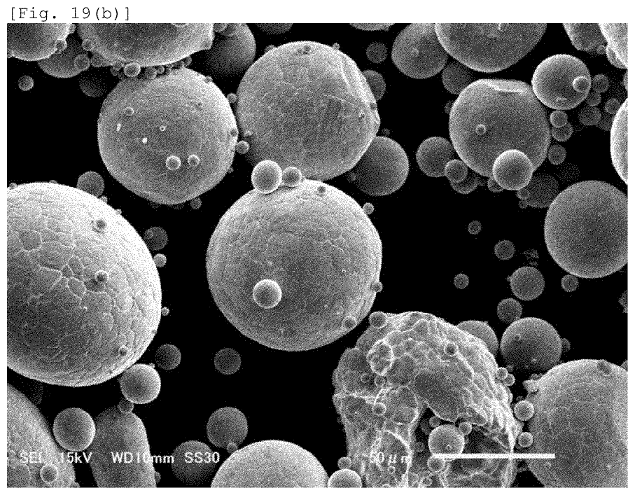

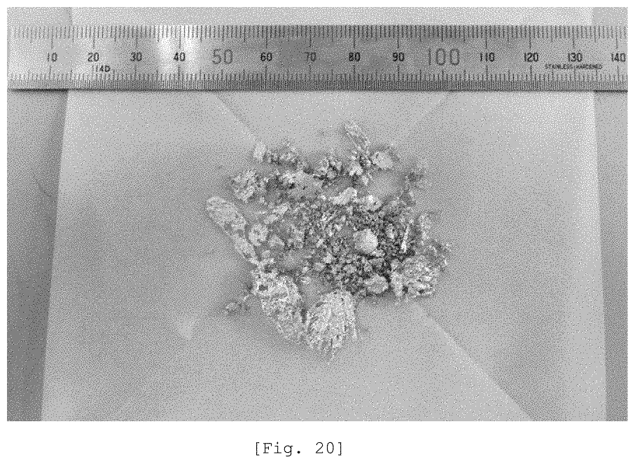

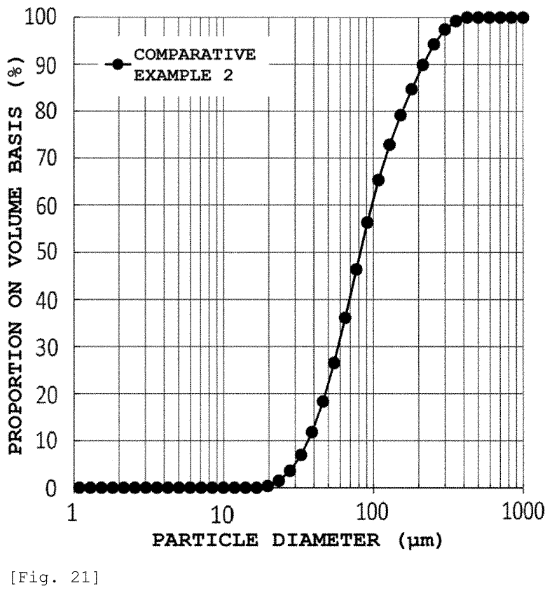

A Pt-10Rh round bar having a size of φ16.0 to 16.5 and 550 mm length was prepared. The Pt-10Rh round bar was used to produce a Pt-10Rh solid spherical powder. Specifically, the Pt-10Rh solid spherical powder was produced by supplying the round bar to an electrode induction melting gas atomization apparatus without producing and pulverizing a hollow spherical powder. From mass measurement, 99.1% of the charged Pt-10Rh round bar turned into the Pt-10Rh solid spherical powder, 0.6% was adhered to the apparatus, and 0.3% volatilized and disappeared. Since this Pt-10Rh solid spherical powder could be clearly confirmed with the naked eye, the Pt-10Rh solid spherical powder was classified using a metal sieve having a mesh size of 150 μm and then observed by being divided into two groups. FIG. 19(a) shows a low-magnification SEM image of the Pt-10Rh solid spherical powder undersize, and FIG. 19(b) shows a high-magnification SEM image thereof. FIG. 20 shows an image of an appearance of a Pt-10Rh powder oversize. Further, FIG. 21 shows a graph of the cumulative particle size distribution of the Pt-10Rh solid spherical powder undersize. From mass measurement, the proportion of the Pt-10Rh powder oversize was 70%, and the proportion of the Pt-10Rh solid spherical powder undersize was 30%. As shown in FIG. 20, the Pt-10Rh powder oversize was a powder in which most of the constituent particles were in a flake shape. On the other hand, as shown in FIG. 19, the Pt-10Rh solid spherical powder undersize was a powder in which most of the constituent particles were spherical or substantially spherical. As shown in FIG. 21, in the particle size distribution, D10 was 36.7 μm, and D90 was 214.1 μm. In addition, from the cumulative particle size distribution, the proportion of the Pt-10Rh solid spherical powder having a particle diameter of 10 μm to 45 μm was about 18% on a volume basis. Therefore, the yield of the Pt-10Rh solid spherical powder having a particle diameter of 10 μm to 45 μm suitable for SLM was 99.1×0.3×0.18≈5% on a volume basis, and only a small amount was obtained with respect to the total processing amount. This Pt-10Rh solid spherical powder was not suitable for a material for SLM.

From the results of observation and measurement, it was shown that, in the method of producing a solid spherical powder in Examples 1 and 2, a highly flowable solid spherical powder that uses a high-melting point and difficult-to-process material as a raw material, that has a high yield, and that is easily formed to a desired particle size is obtained, and a shaped product having a high relative density is obtained by using this solid spherical powder as a material for additive manufacturing. On the other hand, in the powder production method of Comparative Example 1, formation of the wire made of a high-melting point and difficult-to-process material takes time, which was difficult. The obtained solid spherical powder had a wide particle size distribution, and aggregation occurred, and thus Comparative Example 1 was not suitable for the production of a material for additive manufacturing. In Comparative Example 2, it was difficult to produce the round bar because it took time. In addition, in the solid spherical powder obtained in Comparative Example 2, there was a difference that the melting point is lower than each melting point of the solid spherical powder of Examples, but the particle size distribution was wide, most of the solid spherical powder was flaked, and the yield was poor, and thus Comparative Example 2 was not suitable for the production of a material for additive manufacturing.

What is claimed is:

1. A method of producing a solid spherical powder, comprising:
a step A of preparing a first powder raw material containing agglomerated particles and/or solidified particles having a particle diameter of 1 μm to 1,000 μm and introducing the first powder raw material into a plasma flame to produce a hollow spherical powder having a surface layer shell having a thickness of 1 μm to 50 μm; a step B of subjecting the hollow spherical powder to pulverization treatment to pulverize a hollow shape of the hollow spherical powder, thus obtaining a second powder raw material which is solid; and
a step C of introducing the second powder raw material into a plasma flame, melting and solidifying the second powder raw material to obtain the solid spherical powder.

2. The method of producing the solid spherical powder according to claim 1, further comprising a step D of classifying the second powder raw material.

3. The method of producing the solid spherical powder according to claim 1, wherein an apparent density of the solid spherical powder defined in JIS Z 2504: 2012 “Metallic powders-Determination of apparent density” is 50% or more with respect to a true density thereof.

4. The method of producing the solid spherical powder according to claim 1, wherein the pulverization treatment of the hollow spherical powder is impact pulverization.

5. The method of producing the solid spherical powder according to claim 1, wherein the first powder raw material is composed of a metal or an alloy having a melting point of 1,900° C. or higher.

6. The method of producing the solid spherical powder according to claim 5, wherein the metal or the alloy having a melting point of 1,900° C. or higher is any one of Ir, Ru, an Ir-based alloy and a Ru-based alloy.

7. The method of producing the solid spherical powder according to claim 1, wherein the first powder raw material contains at least one of an electrolytic powder, a reduced powder, a mechanically alloyed powder, and a coated powder.

8. A method of producing a shaped product, wherein in an additive manufacturing method comprising a step of laminating layers obtained by at least partially melting and solidifying a powder to be irradiated by high-energy irradiation to form the shaped product, the powder to be irradiated is a solid spherical powder produced by the method of producing the solid spherical powder according to claim 1.

9. The method of producing the shaped product according to claim 8, wherein a relative density of the shaped product is 99% or more.

10. The method of producing the solid spherical powder according to claim 1, further comprising a step E of classifying the solid spherical powder.

11. The method of producing the solid spherical powder according to claim 1, further comprising a step D of classifying the second powder raw material and a step E of classifying the solid spherical powder.
